(19) United States
(12) Patent Application Publication
(10) Pub. No.: US 2009/0036627 A1
(43) Pub. Date: Feb. 5, 2009

(54) AMORPHOUS POLYMERIC NETWORKS

(75) Inventors: Andreas Lendlein, Berlin (DE); Nokyoung Choi, Ludwigshafen (DE)

Correspondence Address: HOGAN & HARTSON LLP;IP GROUP, COLUMBIA SQUARE, 555 THIRTEENTH STREET, N.W., WASHINGTON, DC, 20004, US

(73) Assignee: MNEMOSCIENCE GMBH, Uebach-Palenberg (DE)

(21) Appl. No.: 12/246,262

(22) Filed: Oct. 6, 2008

Related U.S. Application Data
(63) Continuation of application No. 10/534,937, filed on Nov. 17, 2005.

(30) Foreign Application Priority Data
Nov. 15, 2002 (DE) DE 102 53 391.1

(51) Int. Cl. C08F 220/26

(52) U.S. Cl. 526/320

(57) ABSTRACT

The present invention relates to amorphous phase segregated networks of ABA triblock copolymers. The networks do possess good shape memory properties. The materials of the present invention are in particular suitable as materials in the medicinal field, as implants, for the target designed stimuli sensitive drug release, for ligament augmentation or as disc replacement.

The present invention relates to amorphous polymeric networks, intermediate products, suitable for the preparation of the amorphous polymeric networks as well as methods for preparing the intermediate products and the networks.

### PRIOR ART

Polymeric networks are important materials for a variety of uses, in which classic network materials, such as metals, ceramics and wood are, due to their restricted physical properties no longer sufficient. Polymeric networks therefore have established for themselves a broad scope of utilization, in particular also due to the fact that by varying the monomeric units of the polymeric networks, it is possible to adjust the properties of the network.

One particular fascinating class of polymeric networks, which has been developed in recent years, are the so-called shape memory polymers (named in the following shape memory polymers, SMP or SMP materials), i.e. polymeric networks which possess in addition to their actual, visible shape at least one or even more shapes in memory. These shapes can be obtained after having been subjected to a suitable external stimulus, such as a change in temperature. Due to the purposeful shape variation, these materials are of great interest in a vast variety of applications, in which for example a variation in the size is desired. This is, for example, true for medicinal implants, which shall reach their final size preferably only after having been placed into their final position, so that the introduction of these implants requires only minimum invasive chirurgical processes. Such materials are for example disclosed in the international publications WO-A-99-42528 and WO-A-42147. One drawback of the materials disclosed there is, however, that, after subsequent cycles of shape change, it is often no longer possible to reestablish again the primary shape with the desired accuracy. Furthermore, these materials, according to the prior art, due to irreversible creeping processes, do give rise, after repeated shape changes, to a phenomenon which can be described as “wear out”, so that desired physical and geometrical properties are lost over the course of a couple of cycles. A further drawback is the semi crystallinity of most of the materials, in particular of thermoplastic elastomers (TPE). It is, for example, in such materials not possible to distribute pharmacologically active principles, in a homogenous manner, since the permeability in the crystalline areas is much smaller than in the amorphous areas. Such inhomogeneous distribution, however, is for pharmaceutical applications, such as the controlled release of the active principle, not preferred, since it is not possible thereby to secure a constant rate of release of the active principle. Semi-crystallinity is also the reason for the heterogeneous degradation rates of the materials, since crystalline areas degrade much slower than amorphous areas. At the end of the degradation, a brittle crystalline material remains, which is easily broken and which, as implant, can give rise to inflammation. One attempt to overcome these drawbacks is the use of poly(rac-lactide), which is, contrary to poly(L-lactide) amorphous. This material has relatively stable mechanical properties (E-modulus 1400 to 2700 MPa) but this material is hardly elastic. This material can be teared (broken) already at an elongation of from 3 to 10%. Copolymers of lactide and glycolide, having a glycolide content of from 25 to 70 wt % are also amorphous but also suffer from the same drawback, so that this approach cannot be said as being successful.

### OBJECT OF THE INVENTION

It is therefore the object of the present invention to provide polymeric networks, which overcome the drawbacks of the prior art. The polymeric networks should furthermore enable that with a simple variation of the composition an adjustment of the properties becomes possible, so that materials having a desired profile of properties can be tailored.

### SHORT DESCRIPTION OF THE INVENTION

The present invention solves this object by providing the amorphous polymeric network in accordance with claim 1. Preferred embodiments are defined in the dependent subclaims. Furthermore, the present invention provides an intermediate product which is suitable for the preparation of the polymeric amorphous network. Finally, the present invention provides a method for the preparation of the amorphous network in accordance with the present invention, as defined in claim 6, as well as a method for preparing the intermediate product. Preferred embodiment are again disclosed in the dependent subclaims.

### SHORT DESCRIPTION OF THE FIGURES

FIG. 1 shows the concept for the preparation of amorphous, phase segregated networks.

FIG. 2 shows schematically the architecture of the networks.

FIG. 3 shows the mechanical properties of networks during a thermocyclic experiment.

FIG. 4 shows the degradation behavior of the amorphous networks.

### DETAILED DESCRIPTION OF THE INVENTION

In the following, the present invention is described in more detail.

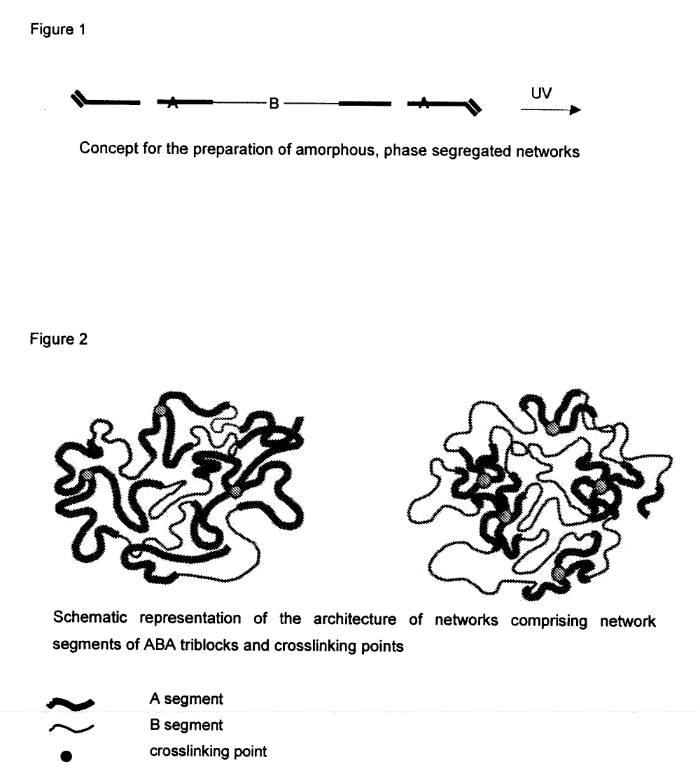

The network in accordance with the present invention comprises a covalently crosslinked polymer, which consists of amorphous phases. The network is formed from a polymeric component, which is an ABA-triblock cooligomer or -copolymer (designated in the following simply as copolymers). The ABA-triblock copolymers are functionalized at the terminals with polymerizable groups and these ABA-triblock copolymers act as macromonomers (FIG. 1). The macromonomers to be used in accordance with the present invention are described in detail in the following.

### ABA-Triblock Copolymers as Macromonomers

The network in accordance with the present invention comprises a polymer component, which does not only show physical interaction but which is present in a covalently crosslinked form.

This network preferably is obtained by crosslinking of functionalized macromonomers. The functionalization enables preferably a covalent crosslinking of the macromonomers with the aid of reactions which do not give rise to side products. Preferably, this functionalization is provided by means of ethylenically unsaturated units, in particular preferably acrylate groups and methacrylate groups, wherein the latter are preferred in particular.

In particular, preferred macromonomers to be used in accordance with the present invention are ABA-triblock copolymers, comprising the crosslinkable terminal groups, preferably of macromonomers comprising polyether blocks and polyester blocks, wherein either the middle B-block is formed from a polyether while the outer A-blocks are formed from a polyester, or vice versa. Preferably, the two outer A-blocks are polyester blocks.

The polyether blocks are based on poly(ethyleneglycol) (PEG), poly(ethyleneoxide) (PEO), poly(propyleneglycol) (PPG), poly(propyleneoxide) (PPO), poly(tetrahydrofurane). A particularly preferred polyether which can be used as B-block is a polyether on the basis of PPO or PPG.

The polyester blocks are based on lactide units, glycolide units, p-dioxanone units, caprolactone units, pentadecalactone units and their mixtures. A in particular preferred polyester, which can be used in accordance with the present invention, is a polyester on the basis of lactide, in particular rac-lactide.

For the preparation of the ABA-triblockcopolymers an oligomeric or polymeric diol is used as difunctional initiator for the ring opening polymerization (ROP). The initiator therefore serves as B-block. As initiator, preferred are polyether diols, which are available with differing molecular weights from commercial sources. Preferred is PPO or PPG. For introducing the A-blocks, cyclic esters or diesters are used as comonomers, such as dilactide, diglycolide, p-dioxanone, ε-caprolactone, ω-pentadecalactone or their mixtures. Preferred in this connection is the use of dilactide, L,L-dilactide, D,L-dilactide, in particular, however, rac-dilactide. The reaction is preferably a bulk reaction, optionally using the addition of a catalyst, such as dibutyltin(IV)oxide. The catalyst is used in amounts of from 0.1 to 0.3 mol %. Without the use of a catalyst, mainly blocky sequences are obtained, such as, for example, L,L- or D,D-lactide sequences. The use of a catalyst results in a more statistical distribution of the monomer units. During the ring opening polymerization of rac-dilactide, no catalyst (no transesterification, respectively) is required. The advantages associated therewith are shorter reaction times and narrower molecular weight distributions. Since the majority of the suitable catalysts, in particular the tin compounds, are toxic, it has to be secured for the use of the ABA-triblock copolymers as material for the medicinal field that the residue of the catalyst remaining in the copolymer is removed. The parameters for these methods are known to the average skilled person and are illustrated in the following examples.

As difunctional initiator, it is preferred to use PPG having a molecular weight of from 400 to 4000 g/mol, in particular with a molecular weight of 4000 g/mol, which corresponds to the length of the B-block.

The length of the A-block can be adjusted by appropriately selecting the molar ratio of monomer to initiator. The weight content of A-blocks within the ABA-triblock copolymers preferably is from 38 to 61%, which corresponds to a molecular weight of the A-blocks of between 1500 and 3200 g/mol.

The molecular weight of the ABA-triblock copolymers 2 (macrodimethacrylate) is not critical and this molecular weight usually is from 3000 to 20000, preferably from 6400 to 10300 g/mol, as determined by ¹H-NMR. n und m are preferably from 10 to 50 and from 10 to 100, respectively, in particular preferably from 15 to 45 and from 50 to 75, respectively.

By varying the molecular weight of the ABA-triblock copolymers, networks can be prepared having differing crosslinking densities (length of the segments between crosslinking points), thereby influencing the mechanical properties. Also the molecular weight distribution influences the properties of the networks. Narrower molecular weight distributions lead to more uniform polymeric networks, which might be of advantage for the reproducibility of desired properties. In principle, it can be stated that with narrower molecular weight distributions, narrower ranges for the transition temperatures can be obtained. Furthermore, it can be stated that lower molecular weights give rise to higher crosslinking densities as well as higher values for mechanical strength, sometimes associated with a decrease of the elastic properties.

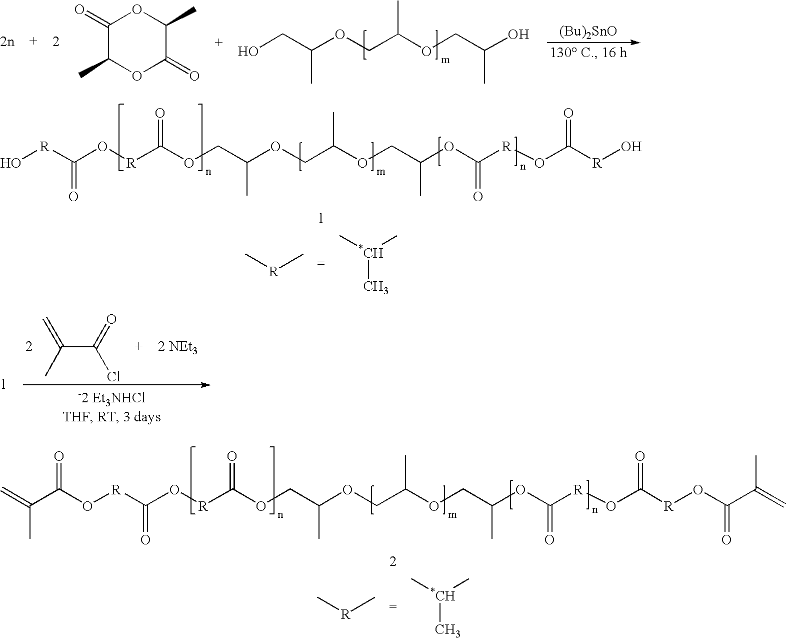

The intermediate products 1 obtained by ring opening polymerization are suitable, after a suitable modification of the terminal groups, for example by introducing terminal acrylate groups, preferably methacrylate groups, for the preparation of the amorphous polymeric networks.

The preparation of such a triblock copolymer, functionalized at both terminals, preferably with metacrylate groups, can occur by simple syntheses, known to the average skilled person. Such a functionalization enables the crosslinking of the macromonomers using simple photo initiation (irradiation).

The reaction (introduction of terminal groups) occurs preferably using methacryloylchloride in the presence of triethyl amine in solution, for example THF as solvent. The reaction parameters required for such a reaction are known to the skilled person. The degree of functionalization, for example when introducing methacrylate terminal groups, is higher that 70%. Typically, degrees of methacrylization of 85 to 99% are obtained, wherein 100% corresponds to the complete functionalization. The intermediate products, functionalized in this manner, are suitable for the preparation of the amorphous polymeric networks in accordance with the present invention. A certain content of not completely functionalized intermediate products is not detrimental. These give rise, during the crosslinking, to loose chain ends or they are present as macrodiols non-covalently crosslinked within the network. Loose chain ends as well as macrodiols are not detrimental, as long as their content is not too high. Degrees of functionalization in the range of from 70 to 100% enable the preparation of polymeric amorphous networks in accordance with the present invention. The preferred range of the molecular weight of the preferred poly(lactide)-b-poly(propyleneoxide)-b-poly(lactide)-dimethacrylate 2 is from 6400 to 10300 g/mol.

The macromonomers (dimethacrylates) can be regarded as tetrafunctional compounds, i.e. they possess crosslinking properties. Due to the reaction of the terminal groups with each other, a covalently crosslinked three-dimensional network is obtained possessing crosslinking points (FIG. 2).

The above-discussed macromonomers (dimethacrylates) are preferably crosslinked to a network by means of UV irradiation. In this manner, networks having a uniform structure are obtained when only one type of macromonomers are employed. If two types of macromonomers are employed, networks of the (ABA)C-type are obtained. Such networks of the (ABA)C-type can also be obtained when functionalized macromonomers are copolymerized with suitable low molecular weight or oligomeric compounds. When the macromonomers functionalized with acrylate groups or methacrylate groups, suitable compounds, which can be copolymerized therewith, are low molecular weight acrylates, methacrylates, diacrylates or dimethacrylates. Preferred compounds of this type are acrylates, such as butylacrylate or hexylacrylate, as well as methacrylates, such as methylmethacrylate and hydroxyethymethacrylate. The advantage of the copolymerization of further macromonomers is the fact that the profile of properties can be tailored further, for example, the mechanical and/or the thermal properties.

The low molecular compounds which can be copolymerized with the macromonomers may be present in an amount of from 5 to 70 wt %, based on the network of macromonomer and low molecular compound, preferably in an amount of from 15 to 60 wt %. By varying the ratio of the amounts of comonomer to macromonomer in the mixture to be crosslinked, it is possible to prepare networks having differing compositions. For high turnovers, it can be stated that the introduction of the comonomers into the networks corresponds to the ratio as given in the mixture to be crosslinked.

The amorphous networks in accordance with the present invention are obtained by crosslinking the macromonomers functionalized at their terminals. Crosslinking can be achieved by means of irradiation of a melt, comprising the macromonomer with the functionalized terminal groups. Suitable process properties therefore are the irradiation of the melt with light having a wavelength of preferably 308 nm.

If the networks are produced by using macromonomers, which macrodiols were obtained using the addition of 0.3 mol % of a catalyst, such as dibutyl tin (IV) oxide, the resulting network shows a tin content of between 300 and 400 ppm (as determined by ICP-AES). When the macrodiols were prepared using a catalyst at a concentration of 0.1 mol %, the tin content in the resulting network is below the detection limit of 125 ppm. Optionally residues of the catalyst can be removed by extraction with chloroform, followed by extraction with diethylether.

The amorphous networks in accordance with the present invention do show the following properties.

Networks without additional comonomers are amorphous and phase segregated. Electromicroscopic views of sections stained with RuOs₄ of preferred networks (A:polyester; B:PPO) do show a two-phasic morphology, in which the PPO phase represents the continuous phase.

Such amorphous networks do have a glass transition point of the polyether phase (preferably PPO) (Tg1) as well as a glass transition point of the polyester phase (Tg2) (can be determined by DSC measurements). The glass transition points are dependent of the type and the block length of the used component and accordingly are adjustable. For networks based on poly(lactide)-b-poly(propyleneoxide)-b-poly(lactide) segments the Tg2 can be adjusted by means of the variation of the length of the A block, for example between 7 and 43° C. (DMTA) and 4 to 29° C. (DSC), respectively, whereas Tg1 lies between −62 and −46° C. The maximum Tg2 which can be obtained for the A block corresponds to the glass transition temperature of the poly(rac-lactide) of about 55 to 60° C. The lowest Tg1 corresponds to the glass transition temperature of the PPC of <−60° C. Accordingly it is possible due to a suitable selection of the blocks to adjust varying differences between Tg1 and Tg2. In general it can be stated that with lower molecular weights of the A blocks Tg1 increases, which can lead, if the difference between Tg1 and Tg2 is only small, to the situation that both glass transition temperatures can no longer be differentiated properly.

By adjusting a low Tg1 elastic properties are obtained which for example are not present in pure poly(rac-lactide).

The amorphous networks in accordance with the present invention generally are good SMP materials having high recovery values, i.e. the initial shape is obtained with a high degree of probability, usually above 90%, even after having been subjected to multiple cycles of shape change. Furthermore no detrimental loss of mechanical properties is detected. The amorphous networks in accordance with the present invention on the basis of poly(lactide)-b-poly(propyleneoxide)-b-poly(lactide) show a glass transition point Tg2 (transition point) associated with a shape transition point. The shape memory properties of the materials in accordance with the present invention are defined in the following.

Shape memory polymers in accordance with the present invention are materials which, due to their chemical-physical structure are able to undergo desired changes in shape. These materials do possess, in addition to their principle permanent shape a further shape, which can be impressed onto the material temporarily. Such materials are characterized by two features. These materials comprise so-called triggering segments or switching segments, which can initiate a transition stimulated by an external stimulus, usually a change in temperature. Furthermore these materials comprise covalent crosslinking points, which are responsible for the so-called permanent shape. This permanent shape is characterized by the three-dimensional structure of the network. The crosslinking points provided in the network in accordance with the present invention are of covalent nature and are obtained in the preferred embodiments of the present invention by means of the polymerization of the terminal methacrylate groups. The triggering segments or switching segments, which initiate the thermally induced transition (shape change) are, in the present invention in relation to the preferred embodiments, the A blocks and the poly(rac-lactide) segments, respectively. The thermal transition point is defined by the glass transition temperature of the amorphous areas (Tg2). Above Tg2 the material is very elastic. If a sample is heated to above the transition temperature Tg2, and if a sample is then deformed in the flexible state and cooled under the transition temperature, the chain segments are fixed due to the reduction of degrees of freedom, so that the deformed shape is fixed (programming). Temporary crosslinking points (non-covalent) are formed, so that the sample cannot recover or return to its original shape, even if the external strain is removed (deformation). Reheating the sample to a temperature of above the transition temperature leads to a removal of the temporary crosslinking points and the sample returns to its original shape. The temporary shape can be obtained again by means of a new programming step. The accuracy with which the original shape is recovered is designated recovery degree.

In polymeric networks having a glass transition temperature as switching temperature the transition is determined kinetically. Accordingly the transition from temporary shape to permanent shape can be conducted in the form of an endless slow process.

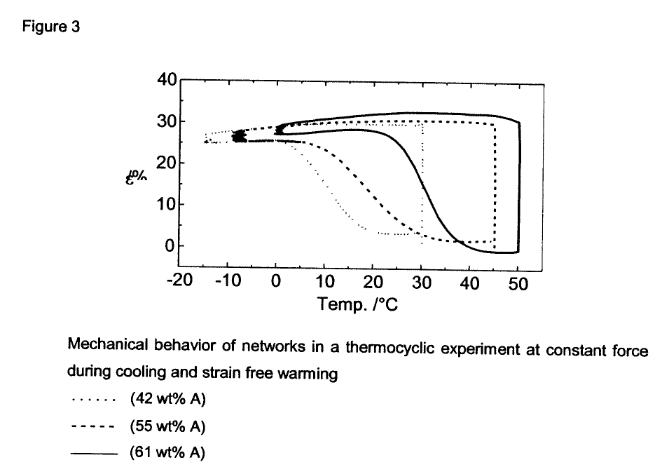

Using suitable strain stress experiments the shape memory effects can be demonstrated. Such strain stress experiments are shown in FIG. 3. The material examined there is an amorphous network having covalently crosslinked poly(lactide)-b-poly(propyleneoxide)-b-poly(lactide) segments. The transition from temporary shape to permanent shape occurs within a relatively broad temperature range. The amorphous networks in accordance with the present invention may comprise, in addition to the above-discussed essential components, further compounds, as long as the function of the network is not affected. Such additional materials can be for example coloring agents, fillers or additional polymeric material, which are used for various purposes. In particular, the amorphous networks in accordance with the present invention, which are to be used for medicinal purposes, may comprise pharmacologically active principles and diagnostic agents, such as contrast agents.

The switching temperatures (transition temperatures) preferably are located in a range so that the use for medicinal applications is enabled where switching temperatures in the range of the body temperature are desired. The materials of the present invention are in particular suitable for use as materials in the medicinal field, as implants, for the target designed stimuli sensitive drug release, as replacement material for inter-vertebrae disks and as ligament augmentation. Furthermore some of the amorphous networks are transparent above as well as below the switching temperature, which is of advantage for certain applications. Such transparent networks may for example be obtained if the single phases of the phase segregated networks are too small to scatter light or when the phases do have similar refractive indices. The network of Example 6 is transparent.

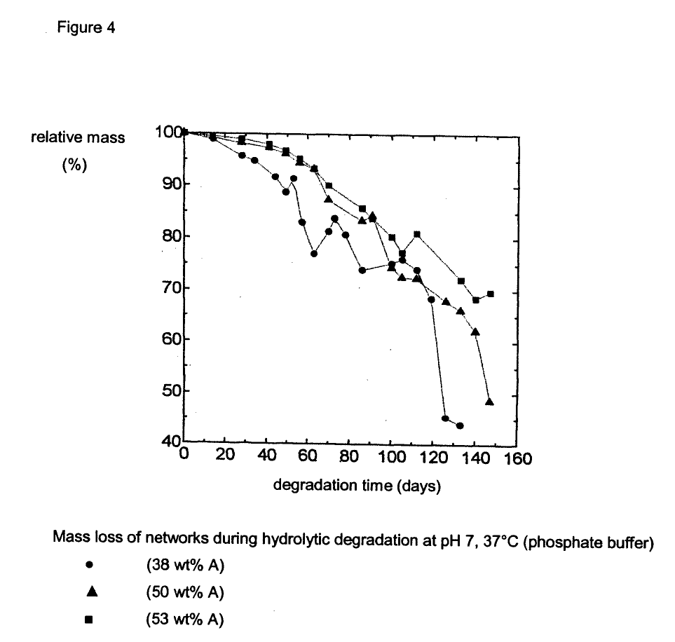

The networks in accordance with the present invention may be degraded in aqueous media by means of a hydrolytic degradation. The hydrolytic degradation starts immediately after immersing the networks in the medium (FIG. 4). The rate of the degradation can be adjusted by means of the weight ratio of the A-blocks and the B-blocks. After a degradation time of about 90 days small particles start to separate from the material. Surprisingly however the material is throughout the degradation amorphous and elastic, the occurrence of crystalline contents could not be determined. The material does not embrittle.

As outlined above it has been shown that the above-described networks are material which do show a shape memory effect, after suitable programming. Further surprising properties are the finding that the materials can be swollen without the danger of tears or breaks, since the materials do show a high elasticity. Furthermore the materials are, as already outlined above, completely amorphous and the shape memory effect can be maintained over multiple cycles of shape changes. Furthermore it has been shown that the materials in accordance with the present invention, when used as shape memory materials, do have superior properties already during programming. The programming of the materials of the present invention comprises the following steps:

The material is present in the normal status, i.e. in the permanent shape.

The material is warmed to a temperature above the glass transition temperature of the amorphous areas (Tg2).

The material is deformed, in order to impress a desired temporary shape.

The material, in the deformed state, is cooled below the glass transition temperature in order to fix the temporary shape.

Thereafter the material can be used and the (repeatable, by means of a new programming) shape memory effect can be triggered by means of warming to a temperature of above Tg2. Thereby the material recovers from the temporary shape to the permanent shape. The materials in accordance with the present invention are characterized in this respect in particular in that the materials do not break when they are cooled in the deformed state. This is a drawback which has been encountered with other shape memory materials.

The following examples further illustrate the invention.

### Preparation of Amorphous Networks

The macro dimethacrylate is distributed evenly on a silanized glass plate and is heated for 5 to 10 minutes in a vacuum to 140 to 160° C., in order to remove gas bubbles from the melt. A second silanized glass plate is placed onto the melt and is fixed using clamps. Between both glass plates a spacer is positioned having a thickness of 0.5 mm.

Networks are obtained by irradiation of the melt with UV light of a wavelength of 308 nm at 70° C. The duration of irradiation was 20 minutes. Differing ABA triblock dimethacrylates were crosslinked in the melt, as shown in the following table. The shape in which the crosslinking occurs corresponds to the permanent shape. The melt can also be crosslinked on substrates of other materials, such as wires, fibers, filaments, films, etc., whereby these substrates are provided with a coating.

| | Mn [H-NMR] | | | | | [PD [GPC] |
|---|---|---|---|---|---|---|
| | ABA Triblock- | | Tg1 | Tg2 | Degree of | ABA- |
| | dimethacrylate | wt. % | (DSC) | (DSC) | methacrylation | Triblock- |
| Example | (g/mol) | A | (° C.) | (° C.) | (%)** | Diols] |
| 1 | 6400 | 38 | * | * | 77 | 1.4 |
| 2 | 6900 | 42 | 10 | 36 | 100 | 1.1 |
| 3 | 8000 | 50 | −41 | — | 64 | 1.3 |
| 4 | 8500 | 53 | −50 | 19 | 56 | 1.7 |
| 5 | 8900 | 55 | −59 | 16 | 99 | 1.4 |
| 6 | 10300 | 61 | −60 | 1 | 115 | 2.3 |

*Sample polymerized during DSC measurement
**Values of above 100 can be explained by contaminations

The polymeric amorphous networks were further evaluated with respect to additional thermal and mechanical properties. The results of these determinations are summarized in the following table.

| | Tg1 | Tg2 | E-Modulus at | Elongation at | Strain at break |
|---|---|---|---|---|---|
| Example | (° C.) | (° C.) | 22° C. (MPa) | break at 22° C. (%) | at 22° C. (MPa) |
| 1 | −51 | 7 | 1.24 | 128 | 1.43 |
| 2 | −60 (−43*) | 4 (11*) | 2.02 | 71 | 0.94 |
| 3 | −46 | n.d. | 1.38 | 218 | 2.18 |
| 4 | −50 | 15 | 4.17 | 334 | 5.44 |
| 5 | −59 (−45*) | 7 (33*) | 4.54 | 110 | 1.89 |
| 6 | −62 (−49*) | 29 (43*) | 6.37 | 210 | 3.92 |

*determined by DMTA; n.d.—not detectable

The shape memory properties were determined using a cyclothermal experiment. For these experiments film samples having a thickness of 0.5 and a length of 10 mm with a width (gauge length) of 3 mm were used which had a dumb-bell shape and which had been prepared by a punching process.

In order to fix the temporary shape the samples were elongated by 30% above Tg2 and were cooled down to below Tg2 at constant strain. In order to trigger the shape memory effect these samples were warmed without strain to above Tg2. The cooling rates and heating rates were 10° C. per minute. FIG. 3 shows a corresponding experiment for an amorphous network in accordance with the present invention, during which the evaluation concerning the shape memory effect had been prepared at Tg2.

These experiments demonstrate the superior properties of the amorphous networks in accordance with the present invention. The networks do show good results for the total recovery ratio after five cycles which is characterizing for the shape memory properties, as summarized in the following table. Materials in accordance with the prior art do often show in these experiments results of less than 80%

| | | Strain | | | |
|---|---|---|---|---|---|
| | | recovery | Temperature | | |
| | Strain | after 5 | range of | Start | [End |
| | fixity | cycles | transition | temperature | temperature |
| Example | (%) | (%)* | (° C.) | of transition | of transition] |
| 1 | 92.9 | 87.5 | 27 | −2 | 25 |
| 2 | 96.0 | 94.1 | 37 | 2 | 39 |
| 3 | 92.0 | 102.2 | 29 | 16 | 45 |

*thermal transition at Tg2

Due to the simple building blocks of the networks in accordance with the present invention a suitable simplicity of the synthesis is secured. By varying the composition, as demonstrated above, polymeric materials can be tailored which do possess desired combinations of properties.

1-10. (canceled)

11. An amorphous shape memory polymeric network comprising a crosslinked ABA triblock dimethacrylate macromonomer produced by a process comprising the steps of:
1) melting the ABA triblock dimethacrylate macromonomer and
2) crosslinking the ABA triblock dimethacrylate macromonomer,
wherein the ABA triblock dimethacrylate macromonomer is derived from polyester and polyether blocks.

12. The amorphous shape memory polymeric network according to claim 11, wherein the polyester is a poly (rac-lactide).

13. The amorphous shape memory polymeric network according to claim 11, wherein the polyester is an A block.

14. The amorphous shape memory polymeric network according to claim 11, wherein the polyether is a polypropylene oxide.

15. The amorphous shape memory polymeric network according to claim 11, wherein the polyether is a B block.

16. The amorphous shape memory polymeric network of claim 11, wherein the amorphous shape memory polymeric network has a recovery value of above approximately 90%.

17. The amorphous shape memory polymeric network of claim 11, wherein the amorphous network is completely amorphous.

18. A method of producing an amorphous shape memory polymeric network comprising:
obtaining an ABA triblock dimethacrylate macromonomer,
melting the ABA triblock dimethacrylate macromonomer, and
crosslinking the ABA triblock dimethacrylate macromonomer to produce the amorphous shape memory polymeric network.

19. The method of claim 18, wherein the ABA triblock dimethacrylate macromonomer is derived from polyester and polyether blocks.

20. The method of claim 18, wherein the polyester is an A block.

21. The method of claim 18, wherein the polyether is a polypropylene oxide.

22. The method of claim 18, wherein the polyether is a B block.

23. A device comprising:
the crosslinked ABA triblock dimethacrylate macromonomer of claim 11,
wherein the device has a temporary first shape and a permanent second shape; and
wherein the device changes from the temporary first shape to the permanent second shape upon exposure to a stimulus.

24. The device of claim 23, wherein the stimulus is a change in temperature.
